(19) United States
(12) Patent Application Publication
(10) Pub. No.: US 2014/0098852 A1
(43) Pub. Date: Apr. 10, 2014

(54) COMPRESSION BANDWIDTH OVERFLOW MANAGEMENT USING AUXILIARY CONTROL CHANNEL

(71) Applicant: SAMSUNG DISPLAY CO., LTD., Yongin-City (KR)

(72) Inventors: Wei Xiong, Mountain View, CA (US); Dale Stolitzka, Los Altos, CA (US)

(73) Assignee: SAMSUNG DISPLAY CO., LTD., Yongin-City (KR)

(21) Appl. No.: 14/046,750

(22) Filed: Oct. 4, 2013

Related U.S. Application Data
(60) Provisional application No. 61/710,601, filed on Oct. 5, 2012.

(51) Int. Cl. H04N 7/26

(52) U.S. Cl. CPC H04N 19/00169
USPC 375/240.02

(57) ABSTRACT

Embodiments of the present invention are directed toward increasing the throughput of information without increasing the data rates in transmission links in order to provide simpler and lower-power data transmission circuits. According to an aspect of the present invention, there is provided a data processor that includes: a compression encoder engine configured to receive a data signal and to compress the data signal to output a compressed data signal; a compression buffer configured to receive the compressed data signal and to buffer the compressed data signal to output a buffered data signal; and a link distributor configured to receive the buffered data signal and to distribute the buffered data signal to at least one of a first distribution signal or a second distribution signal according to a compression ratio.

### CROSS-REFERENCE TO RELATED APPLICATION

This application claims priority to and the benefit of U.S. Provisional Application No. 61/710,601, filed Oct. 5, 2012 in the United States Patent and Trademark Office, the entire content of which is incorporated herein by reference.

### BACKGROUND

1. Field

Embodiments of the present invention relate to a compression bandwidth overflow management apparatus and a method of managing compression bandwidth overflow.

2. Description of the Related Art

For some time now, there has been a growing demand for the distribution of more information and faster transmission of that information. Accordingly, there is pressure to increase the throughput of information via a communication link (e.g., the amount of information transmitted and the speed of the transmission), whether that communication link be a public network, a local network, or cables between devices. This demand for more information and the accompanying pressure for increased information throughput are not expected to abate. For example, there is presently a demand for higher video display resolution and higher frame rates (e.g., the display resolution for televisions is expected to increase from 1920×1080 (2M pixels) to 7680×4320 (32M pixels)). As such, there is pressure to increase the information throughput capabilities of display transmission links (e.g., channels, lanes, or wires) to accommodate the increased resolution and frame rate.

One way to enable increased throughput of information is to increase the rate data is transmitted over a communication link (e.g., increase the number of bits that are transmitted per second). However, in communication links, higher data rates result in more complex circuits and higher power consumption, which in turn, may lead to higher manufacturing and operating costs. Accordingly, what is sought is a way to increase the throughput of information without increasing (or, in some cases, while reducing) the data rate in the communication link.

Compression is one way of transmitting information at a reduced data rate (i.e., reduced as compared to transmitting uncompressed data). In general, two forms of compression exist, lossy compression and lossless compression.

Lossy compression reduces the amount of data (i.e., the number of bits) being transmitted thereby reducing the data rate. Lossy compression reduces the amount of data by reducing data fidelity. Because lossy compression reduces data fidelity, only an approximation of the original data (and therefore the underlying information) can be reconstructed. That is, while lossy compression may reduce the data rate while maintaining the speed of transmission, some of the underlying information is lost. In some applications, transmitting only an approximation of the underlying information is unacceptable.

Lossless compression also reduces the data rate by reducing the amount of data being transmitted. In contrast to lossy compression, however, lossless compression maintains the fidelity of the underlying information. Lossless compression may reduce the amount of data by removing redundancies in the data. An algorithm may record the removed redundancies, which allows the exact original data to be reconstructed when received at the other end of the communication link.

However, in some cases, the amount of redundancies in the data is so small that lossless compression results in little to no reduction of the data rate, or an increase in the data rate due to the algorithm's inefficiencies. As such, the amount of data that can be compressed may vary widely depending on the particular input data. Additionally, it is difficult to predict, a priori, the amount of compression, which forces the communication link to be designed for the worst case scenario of zero compression. In this worst case, the communication link is designed for the maximum uncompressed data rate, hence achieving no appreciable savings.

As described above, it is desirable to increase information throughput without increasing the data rate in communication links in order to avoid higher circuit complexity, manufacturing costs, and power consumption. Compression is one method of increasing information throughput without increasing the transmission data rate. Unfortunately, lossy compression does not offer fidelity of information and lossless compression does not reliably eliminate the issue of high circuit complexity and high power consumption. Accordingly, a more reliable way to transmit information without increasing circuit complexity and power consumption is sought.

### SUMMARY

Embodiments of the present invention are directed toward increasing the throughput of information without increasing the data rates in communication links in order to provide less complex and lower-power data communication circuits. For example, one or more embodiments provide a method and/or apparatus for offloading data from one or more main channels to at least one auxiliary channel based on a compression ratio.

According to an aspect of the present invention, there is provided a data processor that includes: a compression encoder engine configured to receive a data signal and to compress the data signal to output a compressed data signal; a compression buffer configured to receive the compressed data signal and to buffer the compressed data signal to output a buffered data signal; and a link distributor configured to retrieve the buffered data signal and to distribute the buffered data signal to at least one of a first distribution signal or a second distribution signal according to a compression ratio.

According to one embodiment, the data signal has a first bit rate, the compressed data signal has a second bit rate, the compression ratio is a ratio of the first bit rate to the second bit rate, and the first distribution signal has a maximum bit rate.

The compression ratio may vary according to the compressibility of the data signal.

The link distributor may be configured to distribute the buffered data signal entirely to the first distribution signal when the compression ratio is greater than or equal to a reference value.

The link distributor may be configured to: calculate a size of a first portion of the buffered data signal and a size of a second portion of the buffered data signal according to the compression ratio when the compression ratio is less than the reference value; retrieve the first portion and the second portion of the buffered data from the compression buffer when the compression ratio is less than the reference value; distribute the first portion of the buffered data signal to the first distribution signal when the compression ratio is less than the reference value; and distribute the second portion of the buffered data signal to the second distribution signal when the compression ratio is less than the reference value.

The link distributor may be configured to concurrently output the first distribution signal and the second distribution signal. The data processor is configured to provide real time communication.

The reference value may be equal to the ratio of the first bit rate to the maximum bit rate of the first distribution signal.

According to one embodiment, the link distributor is configured to calculate the size of the first portion of the buffered data signal to correspond to the first distribution signal's maximum bit rate and to calculate the size of the second portion of the buffered data signal to correspond to the second distribution signal having a bit rate equal to the first bit rate less the first distribution signal's maximum bit rate.

The compression encoder engine may be configured to apply lossless compression to the data signal, and a maximum bit rate of the data signal may be equal to or smaller than a sum of a maximum bit rate of the first distribution signal and a maximum bit rate of the second distribution signal.

A maximum bit rate of the data signal may be larger than a sum of a maximum bit rate of the first distribution signal and a maximum bit rate of the second distribution signal. The compression encoder engine may be configured to apply lossless compression to the data signal when a bit rate of the data signal is less than or equal to the sum of the maximum bit rate of the first distribution signal and the maximum bit rate of the second distribution signal, and the compression encoder may be configured to apply lossy compression to the data signal when the bit rate of the data signal is greater than the sum of the maximum bit rate of the first distribution signal and the maximum bit rate of the second distribution signal.

An aspect of the present invention provides for a data transmission link including: a data stream source configured to output a data signal; a data processor including: a compression encoder engine configured to receive the data signal and to compress the data signal to output a compressed data signal; a compression buffer configured to receive the compressed data signal and to buffer the compressed data signal to output a buffered data signal; and a link distributor configured to retrieve the buffered data signal and to distribute the buffered data signal to at least one of a first distribution signal or a second distribution signal according to a compression ratio; and a source communication controller configured to receive the first distribution signal and the second distribution signal, the source communication controller including a plurality of forward channels and at least one auxiliary channel, which is bi-directional.

According to one embodiment, the data signal has a first bit rate, the compressed data signal has a second bit rate, the compression ratio is a ratio of the first bit rate to the second bit rate, and the first distribution signal has a maximum bit rate.

The link distributor may be configured to distribute the buffered data signal entirely to the first distribution signal when the compression ratio is greater than or equal to a reference value.

The link distributor may be configured to: calculate a size of a first portion of the buffered data signal and a size of a second portion of the buffered data signal according to the compression ratio when the compression ratio is less than the reference value; retrieve the first portion and the second portion of the buffered data signal from the compression buffer when the compression ratio is less than the reference value; distribute the first portion of the buffered data signal to the first distribution signal when the compression ratio is less than the reference value; and distribute the second portion of the buffered data signal to the second distribution signal when the compression ratio is less than the reference value.

According to one embodiment, the source communication controller includes: a forward channel serializer configured to receive the first distribution signal, to serialize the first distribution signal to generate first serialized data, and to transmit the first serialized data to the forward channels; and an auxiliary channel serializer configured to: receive the second distribution signal and auxiliary data; serialize the second distribution signal to generate second serialized data; and selectively transmit the second serialized data to the at least one auxiliary channel when the serialized data includes the second portion of the buffered data; and selectively pass through the auxiliary data via the at least one auxiliary channel when not transmitting the second serialized data.

The forward channel serializer and the auxiliary channel serializer may be configured to concurrently transmit the first serialized data and the second serialized data. The data transmission link is configured to provide real time communication.

Each of the forward channels has a maximum bit rate, and the first distribution signal's maximum bit rate may be equal to a sum of each of the forward channels' maximum bit rate.

According to an aspect of the present invention, there is provided a method of controlling transmission of data in an apparatus including a plurality of forward channels and at least one auxiliary channel, the method including receiving a data signal having a first bit rate and a maximum bit rate; compressing the data signal to generate a compressed data signal; calculating a compression ratio of the data signal to the compressed data signal; buffering the compressed data signal to generate a buffered data signal; and selectively distributing the buffered data signal to at least one of a first distribution signal or a second distribution signal according to the compression ratio. Here, the first distribution signal and the second distribution signal each have a maximum bit rate, the first distribution signal corresponds to the forward channels, and the second distribution signal corresponds to the at least one auxiliary channel.

The selectively distributing the buffered data signal to at least one of the first distribution signal or the second distribution signal may include: distributing the buffered data signal entirely to the first distribution signal when the compression ratio is greater than or equal to a reference value.

The reference value may be equal to a ratio of the first bit rate to the first distribution signal's maximum bit rate.

The selectively distributing the buffered data signal to at least one of the first distribution signal or the second distribution signal may further include: calculating a size of a first portion of the buffered data signal and a size of a second portion of a buffered data signal according to the compression ratio when the compression ratio is less than the reference value; retrieving the first portion and the second portion of the buffered data signal when the compression ratio is less than the reference value; distributing the first portion of the buffered data signal to the first distribution signal when the compression ratio is less than the reference value; and distributing the second portion of the buffered data signal to the second distribution signal when the compression ratio is less than the reference value.

The method may further include: serializing the first distribution signal to generate first serialized data; demultiplexing the first serialized data to generate a plurality of first serialized data streams; respectively transmitting each of the first serialized data streams to one of the forward channels; serializing the second distribution signal to generate second serialized data when the compression ratio is less than the reference value; transmitting the second serialized data to the at least one auxiliary channel when the compression ratio is less than the reference value; and allowing auxiliary control data to pass via the at least one auxiliary control line when the compression ratio is greater than or equal to the reference value.

### BRIEF DESCRIPTION OF THE DRAWINGS

The above and other aspects of embodiments of the present invention will become more apparent by describing in detail exemplary embodiments thereof with reference to the accompanying drawings, in which:

FIG. 1 is a block diagram depicting a data communication system according to one embodiment of the present invention;

FIG. 2 is a block diagram depicting a source of the data communication system shown in FIG. 1 according to one embodiment of the present invention;

FIG. 3 is a block diagram depicting a source data processor of the source shown in FIG. 2 according to one embodiment of the present invention;

FIG. 3A is a block diagram depicting a compression encoder engine of the source data processor shown in FIG. 3 according to one embodiment of the present invention;

FIG. 3B is a block diagram depicting a link distributor of the source data processor shown in FIG. 3 according to one embodiment of the present invention.

FIG. 4 is a block diagram depicting a source communication controller of the source shown in FIG. 2 according to one embodiment of the present invention;

FIG. 5 is a block diagram depicting a sink of the data communication system shown in FIG. 1 according to one embodiment of the present invention; and

FIGS. 6-10 are flow diagrams illustrating methods of controlling transmission of data according to embodiments of the present invention.

### DETAILED DESCRIPTION

Aspects of the present invention provide a simple and low power data transmission device having a reduced bandwidth requirement and a method for reducing the bandwidth requirement in a data transmission device. For example, one or more embodiments of the present invention provide for offloading data to at least one auxiliary channel based on a compression ratio.

Hereinafter, the present invention will be described more fully with reference to the accompanying drawings, in which, exemplary embodiments of the present invention are shown. As those skilled in the art would realize, the described embodiments are susceptible to various modifications and alternative forms without departing from the spirit or scope of the present invention. For clarity of the description of the present invention, some elements or features not required for the complete understanding of the present invention may be omitted.

The terms used in the present specification are used to describe particular embodiments, and are not intended to limit the present invention. For example, it will be understood that, although the terms “first,” “second,” etc. may be used herein to describe various elements, these elements would not be limited by the strict construction of these terms. These terms are used only to distinguish one component from another. Further, an expression used in the singular encompasses the expression of the plural, unless it has a clearly different meaning in the context. In the present specification, it is to be understood that the terms such as “comprising,” “including,” “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Like reference numerals in the drawings denote like elements, and repeated descriptions thereof may be omitted.

The field of data communication systems covers many industries (e.g., telecom, office, home, etc.) and a variety of media types (e.g., voice, video, databases, etc.). Accordingly, there are a large number ways to implement a particular data communication system. For example, in the area of display communications, data communication may be implemented using DisplayPort™ version 1.2 (hereinafter referred to as displayport), which is a digital display interface standard developed by the Video Electronics Standards Association (VESA)®.

The communication link in displayport includes four forward channels (or the main link) and one bi-directional auxiliary control channel. Here, each of the forward channels is designed to transmit 5.4 Gbps (gigabits per second), which results in 21.6 Gbps total bandwidth for the main link. The auxiliary control channel is designed to transmit up to 720 Mbps (megabits per second), but in some applications, the auxiliary control channel is not deployed, or limited to 1 Mbps.

Presently, it is predicted that advancements within the display industry will demand that the bandwidth provided by digital display communication links double from displayport's 21.6 Gbps to 43.2 Gbps. However, modifying displayport to provide this increased data rate would require an increase in bandwidth of 5.4 Gbps per channel, which may be difficult to implement, and may consume too much power for consumer electronics. An alternative would be to add more channels (e.g., double the forward channels to 8); however, this would also increase cost, and would not be compatible with the existing cables and jacks.

Another alternative is to use compression to reduce the 43.2 Gbps worth of information to fit into the existing channels' total bandwidth. In general, two forms of compression exist, lossy compression and lossless compression. Unfortunately, lossy compression does not offer fidelity of information (which may be incompatible for some applications) and lossless compression does not reliably eliminate the issue of high circuit complexity and high power consumption. Accordingly, a more reliable way to transmit information without increasing circuit complexity and power consumption is sought.

Aspects of the preset invention provide for improving the throughput of information (e.g., increasing the amount of information transferred in a predefined time period) via a communication link (or transmission link) without increasing a maximum data rate of the forward channels of the communication link, thereby simplifying a communication system and saving power. According to one embodiment, information throughput is improved by offloading data to at least one auxiliary channel based on a compression ratio. As used herein, data is defined as the digital representation of information, and may be compressed or uncompressed.

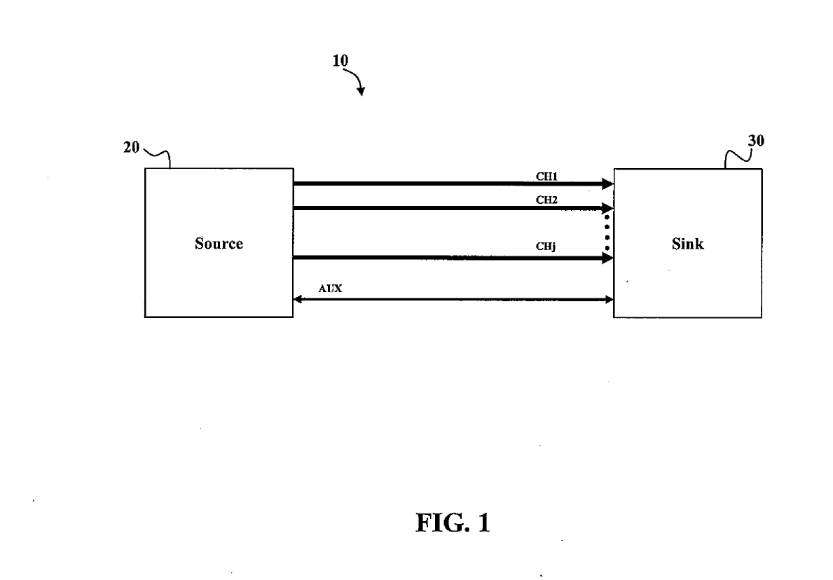

FIG. 1 is a block diagram depicting a data communication system according to one embodiment of the present invention. As shown in FIG. 1, a data communication system 10 includes a source 20 that communicates with a sink 30 over a communication link.

In an embodiment of the present invention, the source 20 may be a device that transmits the data and the sink 30 may be a device which receives the data. For example the communication system 10 may be a home theater system. Here, the source 20 may include a Blue-ray® player, the sink 30 may include a television, and the communication link may include a cable connecting the Blue-ray® player to the television. A person of ordinary skill in the art would recognize that data communication systems according to the present invention are not limited to the above described system, and may be variously implemented to enable communication in a variety of applications. For example, according to another embodiment, both the source and the sink may transmit and receive data, or there may be multiple sources and/or multiple sinks.

According to one embodiment, the communication link includes a plurality of forward channels (or the main link) CH1 to CHj (j being a positive integer greater than 1) and at least one auxiliary channel AUX. For example, an embodiment of the present invention may be configured to include four forward channels CH1 to CH4 and one auxiliary channel AUX so that it is compatible with displayport cables and jacks. However, a person of ordinary skill in the art would recognize that embodiments of the present invention are not limited thereto, and may include any number of forward and auxiliary channels.

According to one embodiment, the forward channels CH1 to CHj (or lanes or collectively, the main link) are high-speed (or high-bandwidth, e.g., more than 1 Gbps) mono-directional channels. The forward channels CH1 to CHj may be low-latency channels. The forward channels CH1 to CHj in the data communication system 10 are used for transmitting a data stream. Each of the forward channels CH1 to CHj may be AC-coupled, doubly-terminated differential pairs. According to one embodiment, each forward channels CH1 to CHj has a bandwidth of 5.4 Gbps. According to one embodiment, there are 4 forward channels CH1 to CH4.

The auxiliary channel AUX, according to one embodiment, is a low speed (e.g., less than 1 Gbps) bi-directional channel. The auxiliary channel AUX may be implement with an AC-coupled, doubly terminated differential pair. The auxiliary channel AUX may implement half-duplex transmission. The auxiliary channel may be controlled to selectively transmit auxiliary data signals (e.g., control, handshake, or link management signals) or a portion of the data stream. According to one embodiment, the auxiliary channel AUX is primarily used for transmitting the auxiliary data signals, and only transmits the portion of the data stream when the bandwidth requirements of the data stream exceed the bandwidth of the forward channels CH1 to CHj.

Hereinafter, for ease of understanding, embodiments of present invention will be described in connection with communication systems having one source, one sink, a plurality of mono-directional high speed channels, and one bi-directional auxiliary communication channel; however, as a person of ordinary skill in the art would recognize, aspects of the present invention may be applied to a variety of communication systems.

As described above, one way to reduce data rates is to use lossless compression. When lossless compression is applied to a data stream, the lossless compression generates compressed data having a variable bit rate. The variable bit rate is due, at least in part, to the compressibility of the data stream. Some data streams, such as those transmitting static graphics, compress easily. Here, the resulting compressed data rate may be as low as 25% of the uncompressed rate. In contrast, some data streams, such as those transmitting dynamic or noisy images, may not compress significantly; for example, they may only compress to 67% of the uncompressed rate. Still other data streams may not compress at all (or may minimally compress), i.e., the worst case scenario. Accordingly, in the related art, a communication link is typically designed and implemented to handle the worst case scenario. That is, the forward channels are designed to be able to transmit uncompressed data, and as such, complexity and power consumption increase as the capacity of information throughput increases.

Aspects of the present invention are directed toward accommodating increased information throughput without increasing the complexity or power consumption of the communication link. For example, one or more embodiments of the present invention provide for offloading data to at least one auxiliary channel based on a compression ratio. Specifically, in one embodiment, the worst case scenario of zero compression is accounted for by using the available bandwidth of the auxiliary channel AUX instead of relying entirely on the forward channels CH1 to CHj.

According to one or more embodiments of the present invention, the communication link is designed to have the forward channels' total bandwidth equal to B (e.g., 0.67) of the bandwidth required to transmit uncompressed data, and to have the auxiliary channel's bandwidth equal to 1-B (e.g., 0.33) of the uncompressed bandwidth. Here, when a bandwidth requirement of the data exceeds the bandwidth available in the forward channels CH1 to CHj, the excess data is transmitted via the auxiliary channel AUX.

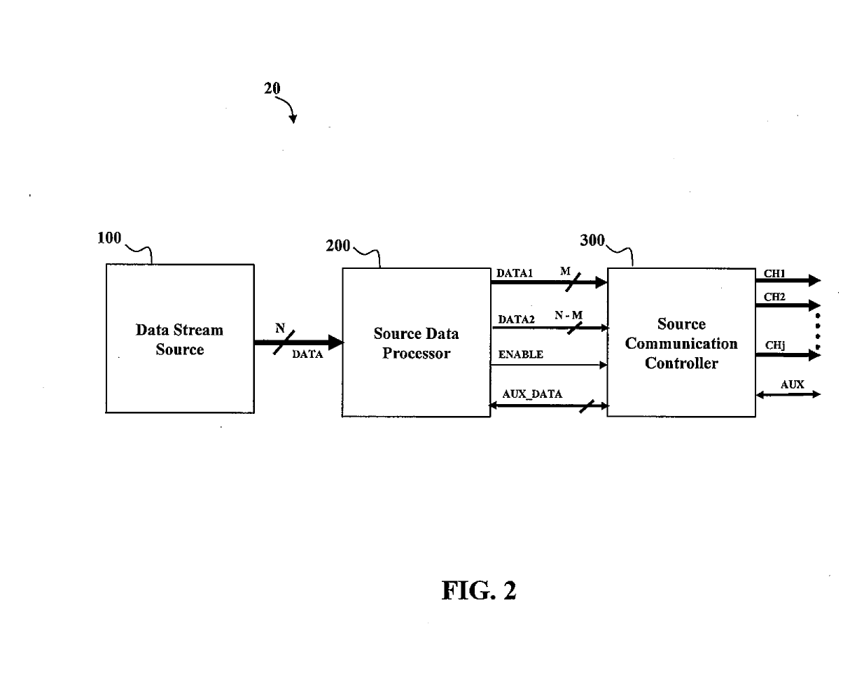

Referring now to FIG. 2, FIG. 2 is a block diagram depicting a source of the data communication system shown in FIG. 1 according to one embodiment of the present invention. The source 20 of FIG. 2 includes a data stream source 100, a source data processor 200, and a source communication controller 300.

The data stream source 100 provides the information to the source data processor 200 via a data signal DATA. According to one embodiment, the data signal DATA transmits N bits of data at a time (e.g., a word). The data signal DATA may be transmitted over a plurality of bit lines, and each bit line may correspond to one of the N bits of the word (i.e., N parallel bits carrying N amount of data). The data signal DATA is provided at a first bit rate (e.g., 43.2 Gbps). The first bit rate may vary or may be constant, and may have a defined maximum bit rate, which may be set to correspond to the total bandwidth of the forward channels CH1 to CHj and the auxiliary channel AUX. According to one embodiment, the data signal DATA transmits uncompressed data representing the information to be transmitted to the sink.

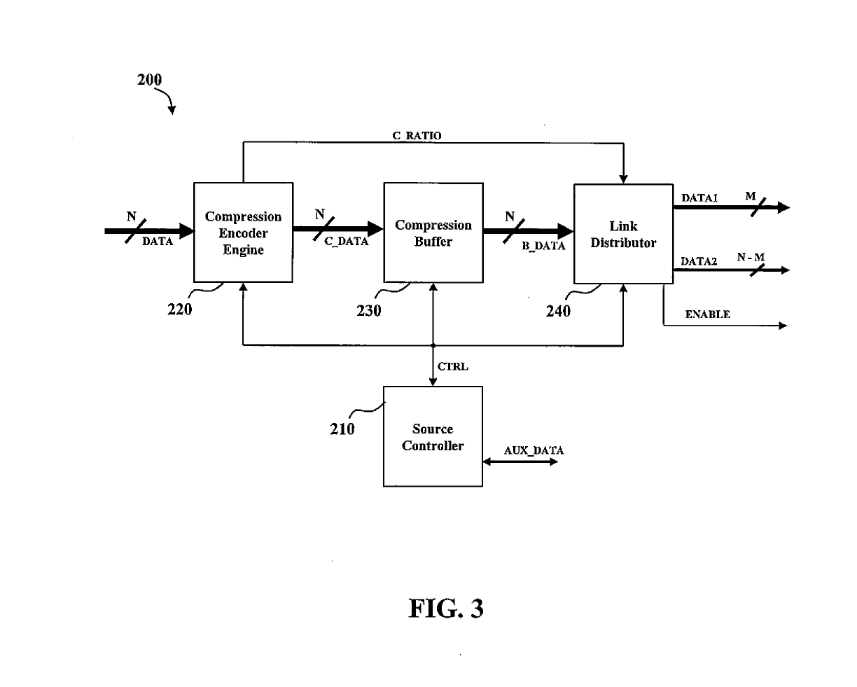

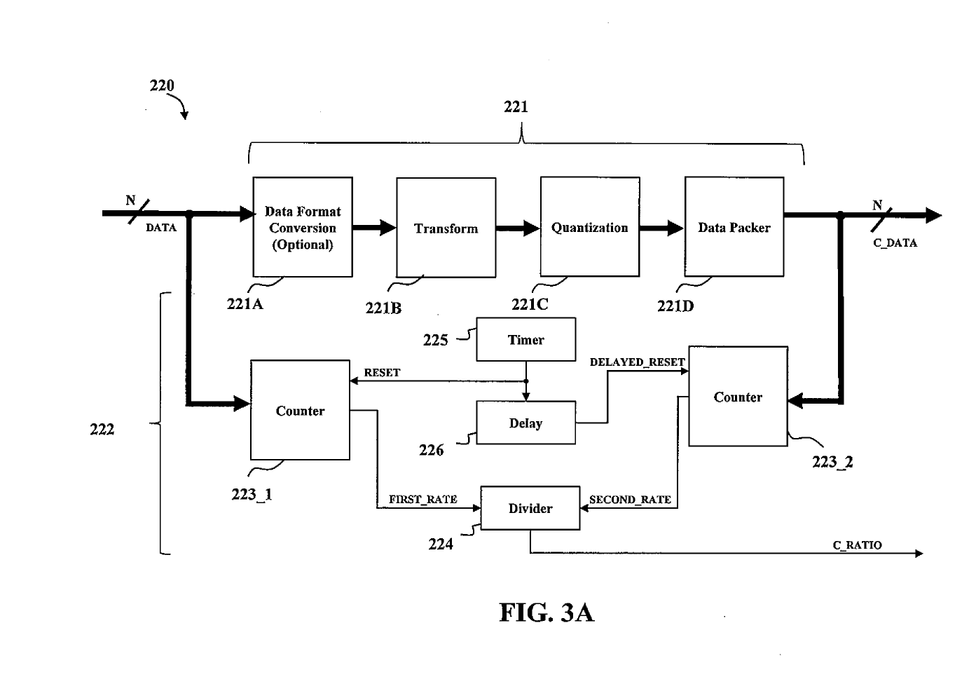

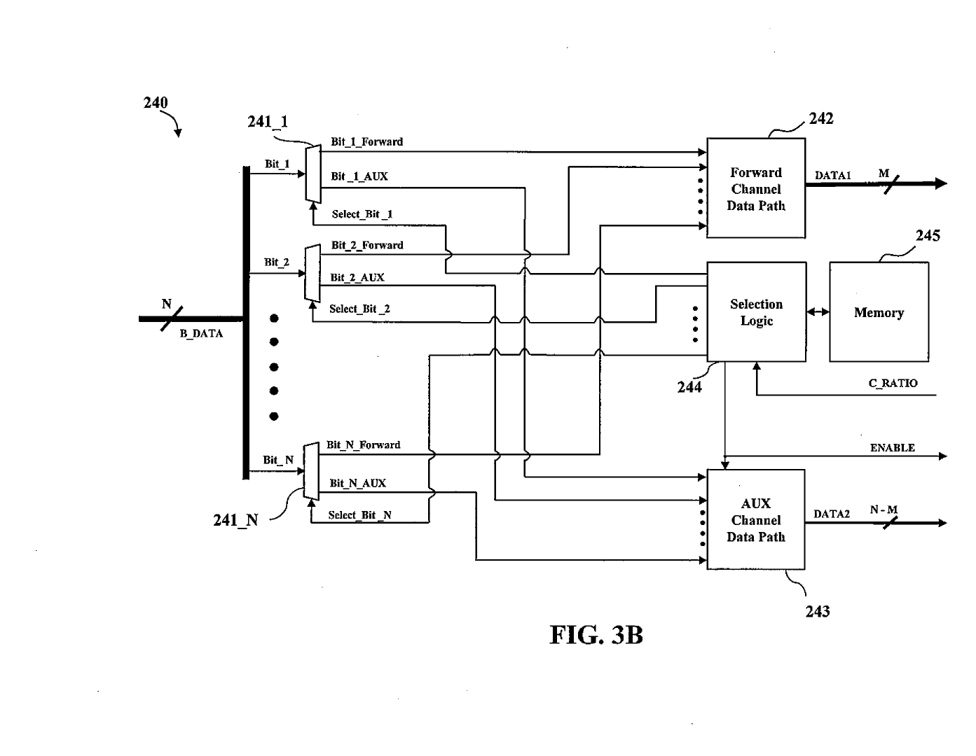

The source data processor 200 receives the data signal DATA having the first bit rate. The source data processor 200 processes the data signal DATA to generate a processed data signal, for example, the source data processor may compress and buffer the data signal DATA. After processing the data signal DATA, the source data processor 200 selectively distributes the processed data to generate distribution signals (e.g., DATA1 and DATA2). The distribution signals are transmitted to the source communication controller 300. A more detailed description of an embodiment of the source data processor 200 is given below in connection with FIGS. 3, 3A, and 3B.

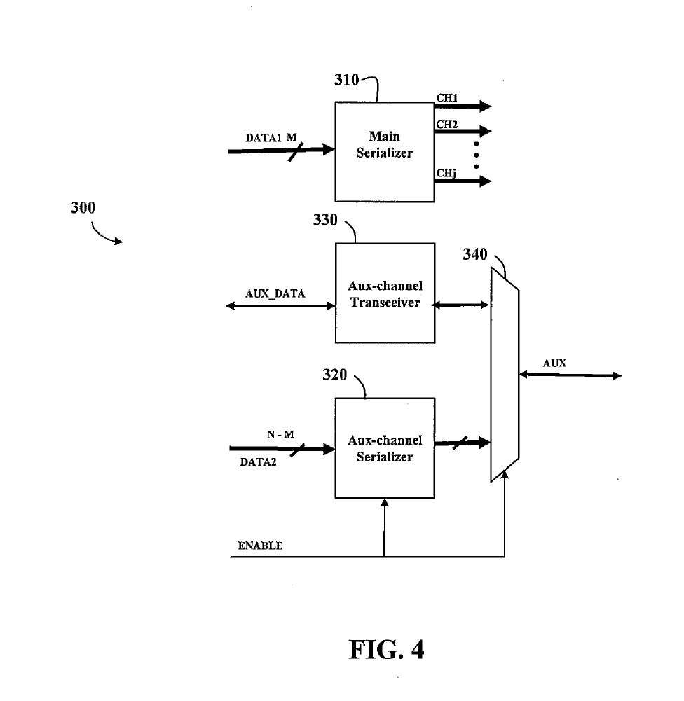

The source communication controller 300, according to one embodiment, receives the distribution signals, serializes the distribution signals, and selectively transmits the distribution signals to the forward channels CH1 to CHj and/or the auxiliary channel AUX. The source communication controller 300 may also selectively interrupt or pass-through the auxiliary control signal. According to one embodiment, selectively interrupting the auxiliary control signal is performed according to an enable signal ENABLE generated by the source data processor 200. A more detailed description of an embodiment of the source communication controller 300 is given below in connection with FIG. 4.

Referring now to FIGS. 3, 3A, and 3B, FIG. 3 is a block diagram depicting a source data processor of the source shown in FIG. 2 according to one embodiment of the present invention, FIG. 3A is a block diagram depicting a compression encoder engine of the source data processor shown in FIG. 3 according to one embodiment of the present invention, and FIG. 3B is a block diagram depicting a link distributor of the source data processor shown in FIG. 3 according to one embodiment of the present invention.

In FIG. 3, the source data processor 200 includes a source controller 210, a compression encoder engine 220, a compression buffer 230, and a link distributor 240.

According to one embodiment, the source controller 210 controls the operation of the source data processor 200. The source controller 210 may receive operating information (e.g., status) from and send control signals (e.g., a clock) to the compression encoder engine 220, the compression buffer 230, and the link distributor 240 via control lines CTRL.

The source controller 210 may also send and receive auxiliary control data AUX_DATA. The auxiliary control data AUX_DATA may include sink control data, handshake data, or link management data. For example, the auxiliary control data AUX_DATA may include a signal that alerts the sink that excess data from the data stream is about to be transmitted via the auxiliary control line AUX.

While the source controller 210 has been described as a distinct element of the source data processor 200, a person of ordinary skill in the art would recognize that the source controller 210 may be incorporated into another element or may be distributed throughout the other elements of the source data processor 200.

The compression encoder engine 220 performs real time compression of the data signal DATA. According to one embodiment, the compression encoder engine 220 performs real time lossless compression of the data signal DATA.

The compression encoder engine 220 receives and compresses the data signal DATA to generate a compressed data signal C_DATA. That is, the compression encoder engine 220 receives the data signal having the first bit rate and compresses it into the compressed data signal C_DATA having a second bit rate. According to one embodiment, the compression encoder engine 220 receives the data signal DATA having N parallel bits carrying N amount of data and compresses it into the compressed data signal C_DATA carrying xN amount of data, where “x” is a compression indication and is less than or equal to one.

According to one embodiment, the compressed data signal C_DATA is transmitted over a plurality of bit lines, each bit line corresponding to one bit of the compressed data signal C_DATA. For example, where the compressed data signal C_DATA contains N amount of data (i.e., the worst case scenario of zero compression), N bit lines may be included for transmitting N amount of data. In the case where the compressed data signal C_DATA contains xN amount of data, the N bit lines may carry the xN amount of data.

While embodiments of the present invention are described herein where the amount of instantaneous data (e.g., maximum number of parallel bits) corresponds to the number of bit lines, a person of ordinary skill in the art would recognize that, in other embodiments, the amount of instantaneous data may be different from the number of bit lines (e.g., the number of bits may be greater than the number of bit lines).

The compression encoder engine 220 generates a compression ratio signal C_RATIO. The compression ratio signal C_RATIO may correspond to the instantaneous ratio of the bit rate (or data rate) of the data signal DATA (i.e., the first bit rate) to the bit rate of the compressed data signal C_DATA (i.e., the second bit rate). That is, the compression encoder engine 220 calculates and transmits the compression ratio.

The compression encoder engine 220 outputs the compressed data signal C_DATA and the compression ratio signal C_RATIO.

FIG. 3A illustrates an example embodiment of the compression encoder engine 220 of FIG. 3. The compression encoder engine 220 of FIG. 3A includes a compressor 221 and a compression ratio calculator 222.

The compressor 221 performs the compression algorithm. That is, the compressor 221 receives the data signal DATA from the data stream source 100, compresses the data signal DATA to generate the compressed data signal C_DATA, and outputs the compressed data signal C_DATA to the compression buffer 230.

According to one embodiment, the compressor 221 includes a data format conversion block 221A, a transform block 221B, a quantization block 221C, and a data packer block 221D. Each of these blocks represents a signal processing operation performed by the compressor to compress the data signal DATA into the compressed data signal C_DATA. While the compressor illustrated in FIG. 3A is illustrated as including each of these operation blocks, other compressors 221 according to other embodiments of the present invention may otherwise be configured. For example, another compressor may omit the data format conversion block.

In general, a compression encoder engine 220 according to embodiments of the present invention may be variously implemented, and as such, may include any of plurality of types of compressors capable of real time (or near real time) compression of a data stream.

According to one embodiment, the compression ratio calculator 222 includes at least one counter 223 and a divider 224. The counter 223 may analyze a signal to determine a bit rate. The divider may analyze at least one data rate to determine a compression ratio.

According to the embodiment of FIG. 3A, the compression ratio calculator 222 includes two counters 223_1 and 223_2. A first counter 223_1 receives the data signal DATA and determines its bit rate, i.e., determines the first bit rate FIRST_RATE. A second counter 223_2 receives the compressed data signal C_DATA and determines its bit rate, i.e., determines the second bit rate SECOND_RATE. The first counter 223_1 and the second counter 223_2 output the first bit rate FIRST_RATE and the second bit rate SECOND_RATE, respectively, to the divider 224.

The divider 224 may receive the first bit rate FIRST_RATE and the second bit rate SECOND_RATE, and may divide the second bit rate SECOND_RATE by the first rate FIRST_RATE to determine the compression ratio C_RATIO. The divider 224 may output the compression ratio C_RATIO to the link distributor 240.

The compression ratio C_RATIO may be calculated by using the counters 223 to converge to a compression ratio. The compression ratio C_RATIO may be based on a running average or may be block based. If the compression ratio is block based, the block may correspond to each frame of data. To this end, the compression ratio calculator 222 may further include a timer 225 and a delay 226.

The timer 225 according to one embodiment periodically transmits a reset signal RESET. For example, the timer 225 may be configured to transmit the reset signal RESET to correspond to the beginning of a new frame of data. The reset signal RESET may be transmitted to the first counter 223_1 and the delay 226.

The first counter 223_1 may reset the calculation of the first data rate FIRST_RATE in response to the reset signal RESET.

According to one embodiment, the processing of the data signal DATA through the compressor 221 results in a delay. As such, at a particular point in time, the data of the compressed data signal C_DATA corresponds to the data of the data signal DATA at an earlier point in time. For the sake of accuracy, the compression ratio calculator 222 may take into account this delay.

For example, the reset signal RESET may be delayed by the delay 226 so that the reset of the second counter 223_2 is delayed. To this end, the delay 226 may receive the reset signal RESET, hold that signal for a predetermined period of time (e.g., a time corresponding to the propagation delay of the compressor 221), and then transmit the signal as a delayed reset signal DELAYED_RESET. By delaying the reset of the second counter 223_2, the compression ratio calculator 222 enables the first and second counters 223_1 and 223_2 to analyze corresponding data.

According to another embodiment, the compression ratio calculator 222 may only include one counter 223 and the divider 224. Here, the counter 223 may determine the second bit rate SECOND_RATE and the divider 224 may determine the compression ratio C_RATIO by dividing the second rate SECOND_RATE by a constant. The constant may correspond to a constant bit rate of the data signal.

Referring back to FIG. 3, the compression buffer 230 receives the compressed data signal C_DATA output from the compression encoder engine 220. The compression buffer 230 temporarily holds the compression data signal C_DATA. According to one embodiment, the compression buffer 230 retrieves and transmits the held compression data signal C_DATA as a buffered data signal B_DATA.

According to one embodiment, the data buffer is a time delay element. That is, the buffered data signal B_DATA may be the delayed compression data signal C_DATA. According to another embodiment, the data buffer is a memory element, and the link distributor requests (or retrieves) a particular portion of the buffered data signal B_DATA. While embodiments of the present invention have been described as having a discrete compression buffer element, embodiments of the present invention are not so limited; for example, the compression buffer may be included in the compression engine or the link distributor.

The link distributor 240 receives (e.g., retrieves) the buffered data signal B_DATA from the compression buffer 230 and receives the compression ratio signal C_RATIO from the compression encoder engine. The link distributor 240 selectively distributes the buffered data signal B_DATA into a plurality of distributed data signals according to the compression ratio signal C_RATIO. According to one embodiment, the link distributor 240 selectively distributes the buffered data signal B_DATA into a first distribution signal DATA1 (corresponding to the forward channels CH1 to CHj) and into a second distribution signal DATA2 (corresponding to the auxiliary channel AUX) based on the compression ratio signal C_RATIO.

According to one embodiment, the link distributor 240 distributes the buffered data signal B_DATA into the first distribution signal DATA1 and the second distribution signal DATA2, concurrently (or simultaneously). The source communication controller 300, may then concurrently receive the first distribution signal DATA1 and the second distribution signal DATA2, and concurrently transmit the distribution signals to the forward channels CH1 to CHj and/or the auxiliary channel AUX. This concurrent distribution and transmission may be done for each cycle (e.g., for each word, frame, packet, etc.) to enable concurrent receipt of the first distribution signal DATA1 and the second distribution data signal DATA2 (via the forward channels CH1 to CHj and the auxiliary channel AUX) such that the buffered data signal B_DATA (e.g., each word, frame, packet, etc. of the buffered data signal B_DATA) may be reassembled by a receiver in each cycle to ensure real time operation.

According to one embodiment, the link distributor 240 calculates the amount of data to be distributed to the forward channels CH1 to CHj and the amount of data (e.g., the excess, overflow, or residual data) to be distributed to the auxiliary channel AUX according to the compression ratio signal C_RATIO (the compression ratio signal C_RATIO may represent the inverse of the compression indication x). For example, the link distributor 240 calculates the appropriate bit rate of the data to be transmitted via the forward channels CH1 to CHj and the appropriate bit rate of the data to be transmitted via the auxiliary channel AUX. The appropriate bit rate for the forward channels CH1 to CHj may be set according to their total maximum bit rate (or total bandwidth), and the appropriate bit rate for the auxiliary channel AUX may be set according to the bit rate of the compressed data signal C_DATA (i.e., the first bit rate) less the total maximum bit rate of the forward channels CH1 to CHj.

For example, for the compressed data signal C_DATA carrying xN bits of data, x being the inverse of the instantaneous compression ratio, the link distributor 240 may calculate that M bits of the xN bits of data should be distributed to the forward channels CH1 to CHj and xN-M bits of the xN bits of data should be distributed to the auxiliary channel AUX. Based on the above calculation, the link distributor retrieves (or selects) the M bits of data from the compression buffer 230 to send the forward channels CH1 to CHj and retrieves (or selects) the xN-M bits of data from the compression buffer 230 to send to the auxiliary channel AUX.

According to one embodiment, the number of bits M is set to be equal to the number of bits xN when xN is less than or equal to the maximum number of bits the forward channels CH1 to CHj is capable of transmitting at a time. In this case, the buffered data signal B_DATA is distributed in its entirety to the forward channels CH1 to CHj (i.e., distributed to the first distribution signal DATA1) and the auxiliary channel AUX may transmit the auxiliary control data AUX_DATA.

In the present embodiment, when the compressed data signal C_DATA has more than the maximum number of bits the forward channels CH1 to CHj are capable of transmitting at a time, M is set to the maximum number of bits of the forward channels CH1 to CHj. Here, M bits of the buffered data signal B_DATA are retrieved and distributed to the forward channels CH1 to CHj via the first distribution signal DATA1, and xN-M bits of the buffered data signal B_DATA are retrieved and distributed to the auxiliary channel AUX via the second distribution signal DATA2.

In the embodiments designed with a forward channel total bandwidth of B (e.g., 0.67) of the required uncompressed bandwidth, for compression ratios greater than 1/B:1 (e.g., 1.5:1), meaning the compressed bandwidth is less than B (e.g., 0.67) of the uncompressed bandwidth, send the compressed data through the forward channels CH1 to CHj; and for compression ratios less than 1/B:1 (e.g., 1.5:1), meaning the compressed bandwidth exceeds the capacity of the forward channels CH1 to CHj, interrupt the operation of the auxiliary channel AUX and send the excess data through the auxiliary channel AUX.

According to one embodiment, the link distributor includes a demultiplexer (or file splitter). For example, the link distributor may include a variable demultiplexer that receives the buffered data signal B_DATA and variously splits the buffered data signal B_DATA into one or more distribution data signals according to the received compression ratio signal C_RATIO.

FIG. 3B illustrates an example embodiment of a link distributor. The link distributor 240 of FIG. 3B includes a plurality of switches 241, a forward channel data path 242, an auxiliary channel data path 243, a selection logic 244, and a memory 245.

The link distributor 240 receives the buffered data signal B_DATA from the compression buffer 230. The buffered data signal may be transmitted by N parallel bits carrying xN amount of data, each bit may be transmitted via one of a plurality of bit lines. Each bit line may be coupled to a corresponding one of the switches 241. The switches 241, according to one embodiment, are controlled (e.g., individually controlled) to selectively distribute the xN amount of data to a forward channel data path 242 or an auxiliary channel data path 243.

According to one embodiment, the switches 241 collectively form (at least a part of) a demultiplexer (e.g., a variable demultiplexer).

As shown in FIG. 3B, the link distributor 240 includes N switches 241_1 to 241_N receiving a corresponding one of the N bits Bit_1 to Bit_N. Each of the switches 241_1 to 241_N is coupled to the forward channel data path 242 via a corresponding one of the forward bit lines Bit_1_Forward to Bit_N_Forward, and is coupled to the auxiliary channel data path 242 via a corresponding one of the auxiliary bit lines Bit_1_AUX to Bit_N_AUX. Further, each of the switches 241_1 to 241_N receives a corresponding one of the bit select signals Select_Bit_1 to Select_Bit_N.

According to one embodiment, each of the switches 241_1 to 241_N is controlled to distribute the corresponding one of the bits Bit_1 to Bit_N to either its forward bit line Bit_1_Forward to Bit_N_Forward or its auxiliary bit line Bit_1_AUX to Bit_N_AUX in response to the corresponding bit select signal Select_Bit_1 to Select_Bit_N. For example when the first switch 241_1 receives the first bit select signal Select_Bit_1, the first switch 241_1 connects to the auxiliary bit line Bit_1_AUX to transmit the first bit Bit_1 to the auxiliary channel data path 242.

According to one embodiment, the bit select signals Select_Bit_1 to Select_Bit_N are generated by the selection logic 244. The selection logic 244 may control each of the bit selection signals Select_Bit_1 to Select_Bit_N individually. The selection logic 244 may activate a particular bit select signal to control its corresponding switch to transmit its bit to the auxiliary channel data path 242.

According to one embodiment, the selection logic 244 activates the bit select signals Select_Bit_1 to Select_Bit_N according to the compression ratio C_RATIO. The selection logic 244 may further consider the capacity of the forward channel and the bit rate of the uncompressed data in controlling the bit select signals Select_Bit_1 to Select_Bit_N. For example, the selection logic may receive capacity of the forward channels as “M”, M being the number of parallel bits of the forward channel for carrying up to M amount of data, and may receive programming information on the sequence of selections from a memory 245. The programming information may be provided by an external source, may be user selectable, or may be determined by an internal state machine (e.g., from a different part of the system), as examples.

According to one embodiment, the selection logic 244 outputs the bit select signals Select_Bit_1 to Select_Bit_N as either a 0 (selecting a forward channel) or a 1 (selecting an auxiliary channel) according to the compression ratio C_RATIO (i.e., 1/x), the capacity of the forward channels M, and the amount of uncompressed data N. For example, the selection logic may calculate the number of 0s to be equal to: min(M, xN). The selection logic 244 generates the bit select signals Select_Bit_1 to Select_Bit_N such that the appropriate number of 0s is transmitted, with the remainder of the signals being set to 1. According to one embodiment, the selection logic sets the bit select signals Select_Bit_1 to Select_Bit_N such that the 0s and 1s are respectively grouped together, e.g., with all the 1s being grouped at the end.

The selection logic 244 may also generate an enable signal ENABLE. The enable signal ENABLE may be transmitted to the source communication controller 300. The enable signal ENABLE may be transmitted to the auxiliary channel data path 243. The enable signal ENABLE may be activated by the selection logic 244 when at least one of the N bits Bit_1 to Bit_N are transmitted to the auxiliary channel data path 243 (e.g., when M<xN).

The forward channel data path 242 may transmit the bits it receives from the forward bit lines Bit_1_Forward to Bit_N_Forward to the source communication controller 300 as the first distribution signal DATA1. The first distribution signal DATA1 may include M parallel bit lines carrying up to M amount of data.

The auxiliary channel data path 243 may transmit the bits it receives from the auxiliary bit lines Bit_1_AUX to Bit_N_AUX to the source communication controller 300 as the second distribution signal DATA2. The second distribution signal DATA2 may include N-M parallel bits carrying xN-M amount of data. The auxiliary channel data path 243 may be enabled by the enable signal ENABLE.

While the link distributor 240 has been described above as having one switch 241 for each of the N bits Bit_1 to Bit_N, the present invention is not so limited. For example, one embodiment of the present invention may only have switches 241 for the bits in excess of the capacity of the forward channel (e.g., N-M switches).

Referring to FIG. 4, FIG. 4 is a block diagram depicting a source communication controller of the source shown in FIG. 2 according to one embodiment of the present invention. The source communication controller 300 of FIG. 4 includes a main serializer 310, an auxiliary channel serializer 320, an auxiliary channel transceiver 330, and a switch 340. The source communication controller 300 (via the main serializer 310 and the auxiliary channel serializer 320) is configured to receive and serialize the first distribution data DATA1 and the second distribution data DATA2.

The main serializer 310 receives the first distribution data signal DATA1 from the link distributor 240. The main serializer 310 serializes the first distribution data DATA1 for transmission via a plurality of forward channels CH1 to CHj. For example, the main serializer 310 may split and serialize the first distribution data signal DATA1 for transmission via four forward channels CH1 to CH4. The serialized data may be transmitted to the forward channels via a transmitter (or a transceiver).

The auxiliary channel serializer 320 receives the second distribution data signal DATA2 from the link distributor 240. The auxiliary channel serializer 320 serializes the second distribution data signal DATA2 for transmission via at least one auxiliary channel AUX. The serialized data may be transmitted to the auxiliary channel AUX via a transmitter (or a transceiver). As described above, the second distribution data signal DATA2 may contain data when amount of data of the buffered data signal B_DATA exceeds the bandwidth of the forward channels CH1 to CHj. Accordingly, the auxiliary channel serializer 320 may not serialize the second distribution data signal DATA2 when this data signal is empty.

According to one embodiment, the auxiliary channel serializer 320 is configured to operate when it receives the enable signal ENABLE. The enable signal ENABLE may be generated by the source data processor 200, and indicates that the second distribution data signal DATA 2 is not empty.

According to one embodiment, when the serialized second distribution data signal DATA2 is transmitted, the serialized second distribution data signal DATA2 is transmitted concurrently (or simultaneously) with the serialized first distribution data signals DATA1.

According to one embodiment, when the auxiliary channel serializer 320 is not transmitting the second distribution data signal DATA2, the auxiliary channel is available to send and receive the auxiliary control data signal AUX_DATA.

Here, the source communication controller 300 may selectively allow the auxiliary control data signal AUX_DATA to pass through when the second distribution data signal DATA2 is empty. For example, the switch 340 may be operated to selectively connect the auxiliary channel AUX to one of the auxiliary channel transceiver 330 to send and receive the auxiliary control data signal AUX_DATA or to the auxiliary channel serializer 320 to send the second distribution data signal DATA2. The switch 340 may be controlled according to the enable signal ENABLE.

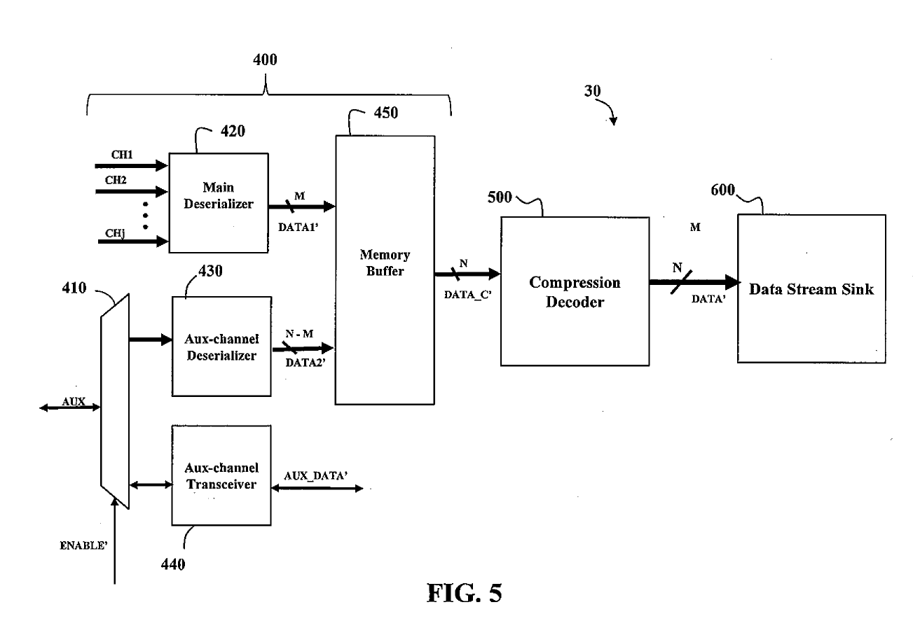

Referring now to FIG. 5, FIG. 5 is a block diagram depicting a sink of the data communication system shown in FIG. 1 according to one embodiment of the present invention.

In FIG. 5, the sink 30 includes a sink communication controller 400, a compression decoder 500, and a data stream sink 600. The sink 30 communicates with the source 20 over the communication link. The communication link may include the forward channels CH1 to CHj and the auxiliary channel AUX. According to one embodiment, the sink 30 receives data via the forward channels CH1 to CHj, and receives overflow data or auxiliary data via the auxiliary channel AUX.

The sink communication controller 400 is coupled to the forward channels CH1 to CHj and the auxiliary channel AUX. The sink communication controller 400 receives at least one of a serialized data stream or an auxiliary control signal. The serialized data stream may be transmitted via the forward channels CH1 to CHj or may be transmitted via the forward channels CH1 to CHj and the auxiliary channel AUX. According to one embodiment, the serialized data stream is transmitted via only the forward channels CH1 to CHj when the bandwidth of the forward channels CH1 to CHj is greater than or equal to the bandwidth requirement of the serialized data stream; and the serialized data stream is transmitted via both the forward channels CH1 to CHj and the auxiliary control channel AUX when the bandwidth requirement of the serialized data stream exceeds the bandwidth capacity of the forward channels CH1 to CHj.

The sink communication controller 400 may include a switch 410, a main deserializer 420, an auxiliary channel deserializer 430, an auxiliary channel transceiver 440, and a memory buffer 450.

The main deserializer 420 is coupled to the forward channels CH1 to CHj and receives the portion of the serialized data stream transmitted via the forward channels CH1 to CHj. According to one embodiment, the portion of the serialized data stream transmitted via the forward channels CH1 to CHj corresponds to the first distribution signal DATA1. When the bandwidth requirement of the serialized data stream is satisfied by the capacity of the forward channels CH1 to CHj, the portion of the serialized data stream transmitted via the forward channels CH1 to CHj may correspond to the entirety of the serialized data stream.

The main deserializer 420 receives the portion of the serialized data transmitted via the forward channels CH1 to CHj and reconstructs the data signal corresponding to the first distribution data signal DATA1. That is, the main deserializer 420 outputs the first reconstructed data signal DATA1′. The main deserializer 420 may output the first reconstructed data signal DATA1′ to the memory buffer 450. The first reconstructed data signal DATA1′ may be transmitted via M parallel bits having a capacity of M amount of data.

The switch 410 is coupled to the auxiliary channel AUX. As describe above, the auxiliary channel AUX may transmit the auxiliary control signal AUX_DATA or may transmit an overflow portion of the serialized data stream (e.g., a portion corresponding to the serialized second distribution data signal DATA2). The switch 410 is controlled to send the data signal received via the auxiliary channel AUX to the auxiliary channel deserializer 430 and the auxiliary channel transceiver 440.

The switch 410 is controlled to send the data signal from the auxiliary channel AUX to the auxiliary channel deserializer 430 when the auxiliary channel is carrying the overflow portion of the serialized data stream. According to one embodiment, the switch 410 is controlled according to a sink enable signal ENABLE′ to couple the auxiliary channel AUX to the auxiliary channel deserializer 430 when the sink enable signal ENABLE′ is activated. The sink enable signal ENABLE′ may be generated according to the auxiliary control signal AUX_DATA′ received prior to the overflow portion of the data stream.

The auxiliary channel deserializer 430 receives the overflow portion of the serialized data stream transmitted via the auxiliary channel AUX and reconstructs the data signal corresponding to the second distribution data signal DATA2. That is, the auxiliary channel deserializer 430 outputs the second reconstructed data signal DATA2′. The auxiliary channel deserializer 430 may output the second reconstructed data signal DATA2′ to the memory buffer 450. The second reconstructed data signal DATA2′ may be transmitted via N-M parallel bits carrying xN-M amount of data.

The auxiliary channel transceiver 440 sends and receives the auxiliary control signal AUX_DATA′.

According to one embodiment, the memory buffer 450 receives the first and second reconstructed data signals DATA1′ and DATA2′ to generate the reconstructed compressed data signal DATA_C′. For example, the memory buffer 450 may combine the first and reconstructed data signals DATA1′ and DATA2′ to generate the reconstructed compressed data signal DATA_C′. According to one embodiment, the reconstructed compressed data signal DATA_C′ corresponds to the compressed data signal DATA_C generated by the source 20.

The memory buffer 450 outputs the reconstructed compressed data signal DATA_C′ to the compression decoder 500. According to one embodiment, the reconstructed compressed data signal DATA_C′ includes N bits carrying xN amount of data, where “x” is the compression indicator less than or equal to 1.

The compression decoder 500 receives the reconstructed compressed data signal DATA_C′ and decompresses the signal to generate the reconstructed data signal DATA′. The reconstructed data signal DATA′ corresponds the data signal generated by the source 20.

The compression decoder 500 outputs the reconstructed data signal DATA′ to the data stream sink 600 as N parallel bits carrying N amount of data.

The data stream sink 600 receives the reconstructed data signal DATA′ and processes that signal. Accordingly, information that is generated by the source 20 is received by the sink 30.

According to the above described features and aspects of the present invention, a communication link may be provided that allows for an improved throughput of information without increasing complexity or power consumption.

While embodiments of the present invention have been described in connection with lossless compression, aspects of the present invention may also be used with lossy compression, for example, to improve image reconstruction quality due to increased total bandwidth. Because embodiments of the present invention provide increased bandwidth, an increase in the link bandwidth allows the coding system to use high bits/per pixel (less compression) and improve lossy coding results.

According to one embodiment, when using lossy compression, the link distributor is configured to distribute the buffered data signal B_DATA entirely to the first distribution signal DATA1 while the compression ratio and/or the data fidelity are within an appropriate (or predefined range). Here, when the compression ratio and/or the data fidelity fall outside the appropriate range, the link distributor distributes a portion of the buffered data signal B_DATA to the second distribution signal DATA2 to be transmitted via the auxiliary channel AUX. The appropriate range may be set according to the application; for example, in a high definition display application, the requirement for data fidelity may be high (e.g., 90% or higher data fidelity).

According to one embodiment, the compressed data signal C_DATA may vary to have a bit rate greater than the sum of the bit rate of the forward channels CH1 to CHj and the auxiliary channel AUX (i.e., the total bandwidth). In this case, the compression engine may use lossless compression while the data signal DATA is compressible to a compressed data signal C_DATA that has a bit rate that is equal to or less than the total bandwidth, and may use lossy compression when the data signal DATA is incapable (at least practically) of being losslessly compressed into a data signal having a bit rate less than or equal to the total bandwidth.

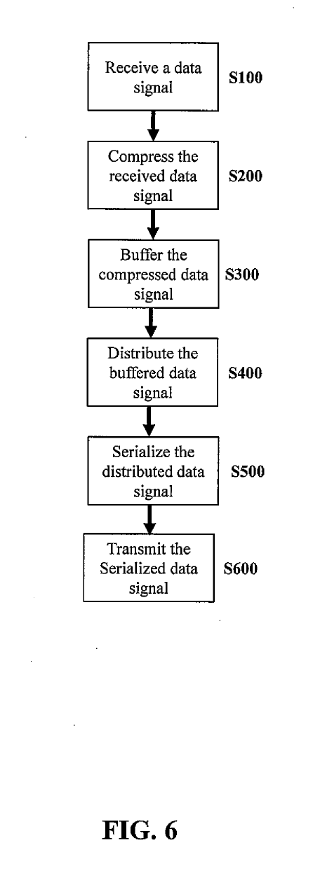

Hereinafter, a method of controlling transmission of data according to one or more embodiments of the present invention is described in connection with FIGS. 6-10, which are flow diagrams illustrating methods of controlling transmission of data.

FIG. 6 is a flow diagram illustrating one method of controlling transmission of data according to an embodiment of the present invention. As shown in FIG. 6, the method includes: receiving a data signal (S100); compressing the received data signal (S200); buffering the compressed data signal (S300); distributing the buffered data signal (S400); serializing the distributed data signal (S500); and transmitting the serialized data signal (S600).

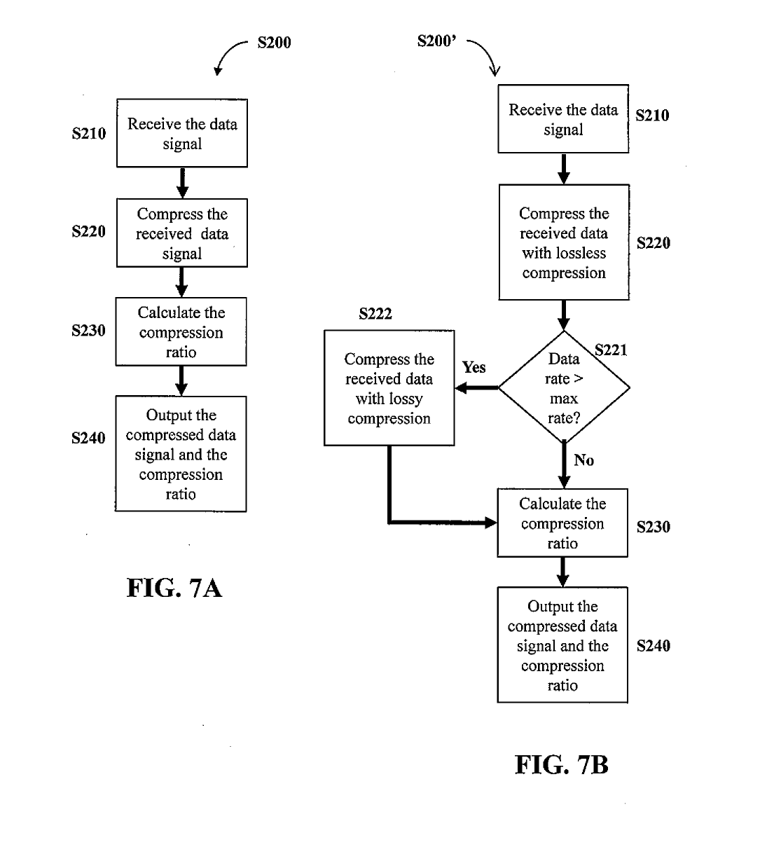

FIGS. 7A and 7B are flow diagrams illustrating embodiments of the operation of compressing the received data signal included in the method of controlling the transmission of data shown in FIG. 6.

As shown in FIG. 7A, the operation of compressing the received data signal (S200) includes: receiving the data signal (S210); compressing the received data signal (S220); calculating the compression ratio (S230); and outputting the compressed data signal and the compression ratio (240). According to one embodiment, the operation of compressing the received data signal (8200) shown in FIG. 7A is performed using one type of compression; e.g., lossless compression.

In contrast, the operation of compressing the received data signal (S200′) shown in FIG. 7B may perform more than one type of compression (e.g., lossy and lossless compression). Here, the operation of compressing the received data signal (S200′) begins with receiving the data signal (S210) and then compressing the received data signal with lossless compression (S220). Next, the data rate of the lossless compressed data signal is evaluated (S221).

If the data rate is greater than the maximum data rate of the forward channels (or the forward and auxiliary channel), the received data signal is compressed with lossy compression (the lossless compression data may also be discarded) (S222). If the data rate is less than or equal to the maximum data rate of the forward channels, the method proceeds using the lossless compressed data signal.

Next, the compression ratio is calculated (S230), and the compressed data signal and the compression ratio are output (S240) for use in the next operation.

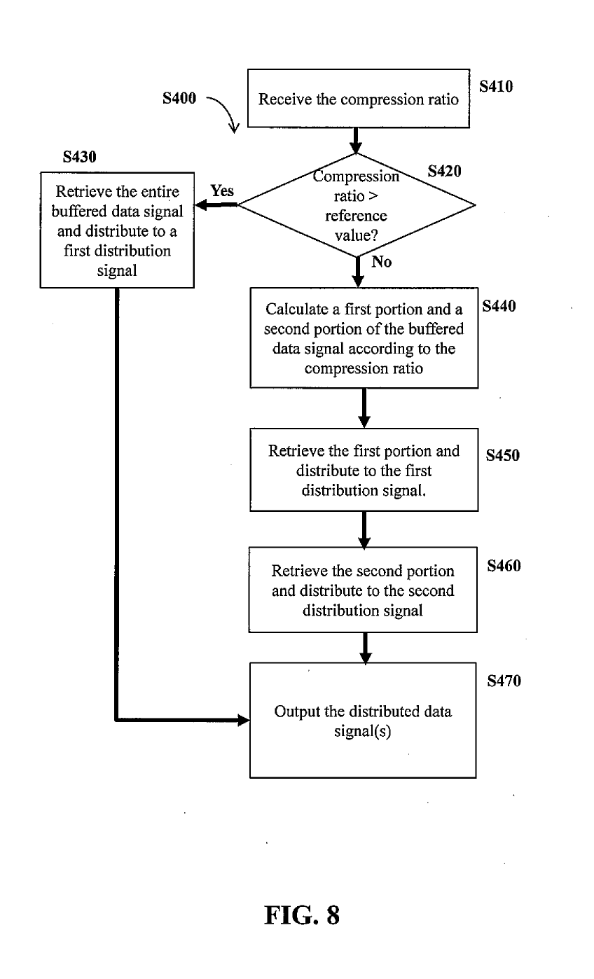

FIG. 8 is a flow diagram illustrating an embodiment of the operation of distributing the buffered data signal included in the method of controlling the transmission of data shown in FIG. 6.

The operation of distributing the buffered data signal (S400) according to one embodiment begins with receiving the compression ratio (S410).

The compression ratio is compared with a reference value (S420). The reference value may correspond to the capacity of the forward channels (or the forward and auxiliary channels) or may correspond to a suitable compression ratio (e.g., suitable for high definition video).

If the compression ratio is greater than (or equal to) the reference value, the entire buffered data signal is distributed to a first distribution signal (S430). According to one embodiment, the entire buffered data signal is distributed to the first distribution signal when the total capacity of the forward channels is suitable to transmit the entire buffered data signal. When the buffered data signal is distributed to the first distribution signal, an auxiliary control signal may be transmitted over the auxiliary channel.

If the compression ratio is less than the reference value, at least a portion of the buffered data signal is distributed to the auxiliary channel. According to one embodiment, the portion of the buffered data signal that is distributed to the auxiliary channel corresponds to the excess data that surpasses the capacity of the forward channels.

Alternatively, in the embodiment illustrated in FIG. 8, a first portion and a second portion of the buffered data signal are calculated according to the compression ratio when the compression ratio is less than or equal to the reference value (S440). Here, the first portion is retrieved and distributed to the first distribution signal (S450), and the second portion is retrieved and distributed to the second distribution signal (S460).

Finally, the distributed data signals (i.e., the first and/or the second distribution signals) are output (S470) for use in the next operation.

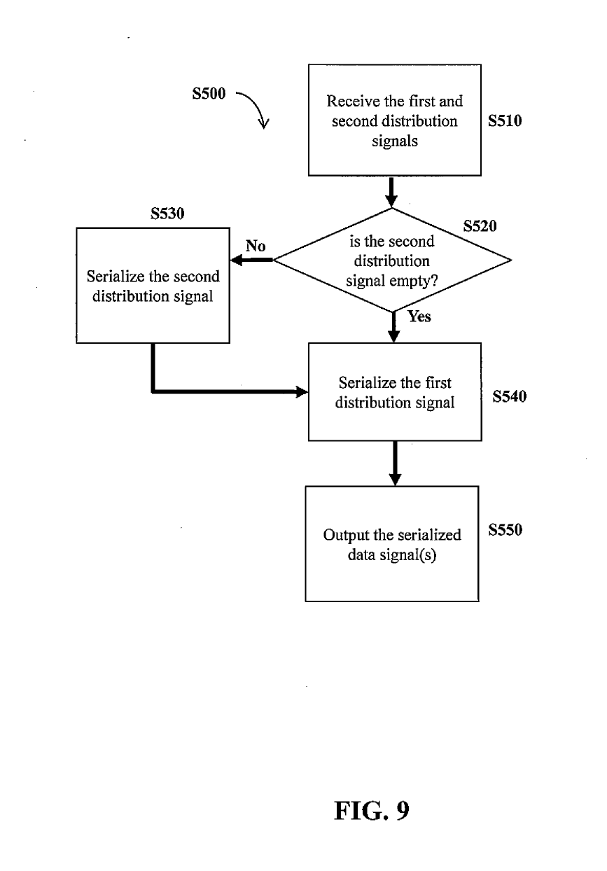

FIG. 9 is a flow diagram illustrating an embodiment of the operation of serializing the distributed data signals included in the method of controlling the transmission of data shown in FIG. 6.

The operation of serializing the distributed data signals according to the embodiment of FIG. 9 begins with receiving the first and second distribution signals (S510) and determining whether or not the second distribution signal is empty (S520).

If the second distribution signal is not empty, the second distribution signal is serialized (S530). Additionally, the auxiliary control signal may be interrupted when the second distribution signal is not empty.

Whether or not the second distribution signal is empty, the first distribution signal is serialized (S540). According to one embodiment, serializing the first distribution signal is performed concurrently with serializing the second distribution signal. The first distribution signal may be serialized into plurality of lanes. Each lane may correspond to one of the forward channels of the main link.

Finally, the serialized data signals (e.g., the first and/or the second serialized data signals) are output (S550) for use in the next operation.

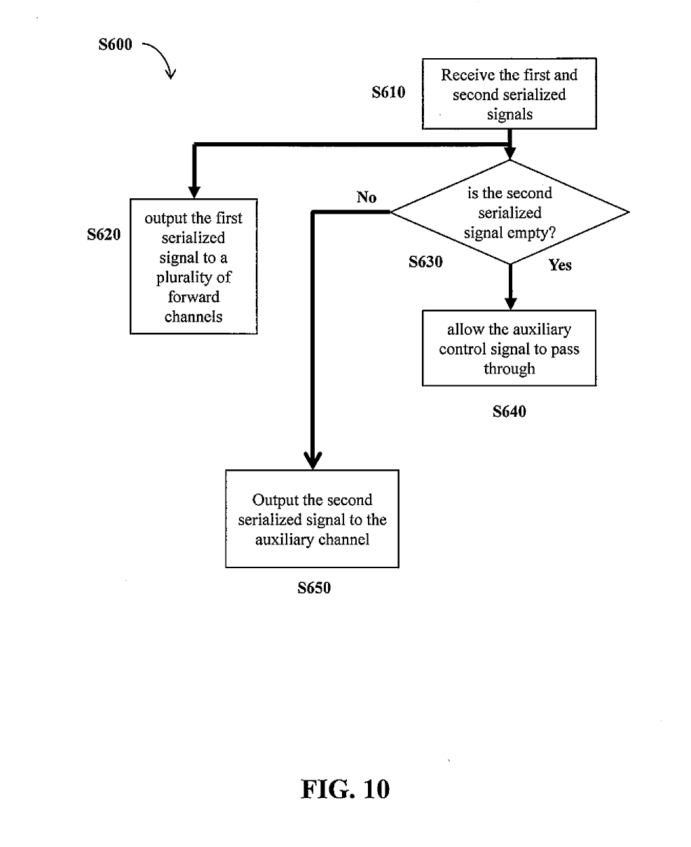

FIG. 10 is a flow diagram illustrating an embodiment of the operation of transmitting the serialized data signals included in the method of controlling the transmission of data shown in FIG. 6.

As an initial operation, the first and second serialized signals are received (S610). The first serialized signal is output to a plurality of forward channels (S620). As described above, the first serialized signal may be received via a plurality of lanes, where each lane corresponds to one of the forward channels.

Also, it is determined whether or not the second serialized signal is empty (S630). If it is empty, the auxiliary control signal is allowed to pass through (S640). However, if it is not empty, the second serialized signal is output to the auxiliary channel (S650).

According to aspects of the present invention, the above described embodiments of a method for controlling the transmission of data over a communication link provide improved throughput of information without increasing complexity or power consumption.

While embodiments of the present invention have been particularly shown and described with reference to exemplary embodiments thereof, it will be understood by those of ordinary skill in the art that various changes in form and details may be made therein without departing from the spirit and scope of the present invention as defined in the following claims and their equivalents.

What is claimed is:

1. A data processor comprising:
a compression encoder engine configured to receive a data signal and to compress the data signal to output a compressed data signal;
a compression buffer configured to receive the compressed data signal and to buffer the compressed data signal to output a buffered data signal; and
a link distributor configured to retrieve the buffered data signal and to distribute the buffered data signal to at least one of a first distribution signal or a second distribution signal according to a compression ratio.

2. The data processor of claim 1,
wherein the data signal has a first bit rate,
wherein the compressed data signal has a second bit rate,
wherein the compression ratio is a ratio of the first bit rate to the second bit rate, and
wherein the first distribution signal has a maximum bit rate.

3. The data processor of claim 2, wherein the compression ratio varies according to the compressibility of the data signal.

4. The data processor of claim 2, wherein the link distributor is configured to distribute the buffered data signal entirely to the first distribution signal when the compression ratio is greater than or equal to a reference value.

5. The data processor of claim 4, wherein the link distributor is configured to:
calculate a size of a first portion of the buffered data signal and a size of a second portion of the buffered data signal according to the compression ratio when the compression ratio is less than the reference value;
retrieve the first portion and the second portion of the buffered data signal from the compression buffer when the compression ratio is less than the reference value;
distribute the first portion of the buffered data signal to the first distribution signal when the compression ratio is less than the reference value; and
distribute the second portion of the buffered data signal to the second distribution signal when the compression ratio is less than the reference value.

6. The data processor of claim 5,
wherein the link distributor is configured to concurrently output the first distribution signal and the second distribution signal, and
wherein the data processor is configured to provide real time communication.

7. The data processor of claim 5, wherein the reference value is equal to the ratio of the first bit rate to the maximum bit rate of the first distribution signal.

8. The data processor of claim 5, wherein the link distributor is configured to calculate the size of the first portion of the buffered data signal to correspond to the first distribution signal's maximum bit rate and to calculate the size of the second portion of the buffered data signal to correspond to the second distribution signal having a bit rate equal to the first bit rate less the first distribution signal's maximum bit rate.

9. The data processor of claim 1,
wherein the compression encoder engine is configured to apply lossless compression to the data signal, and
wherein a maximum bit rate of the data signal is equal or less than a sum of a maximum bit rate of the first distribution signal and a maximum bit rate of the second distribution signal.

10. The data processor of claim 1,
wherein a maximum bit rate of the data signal is larger than a sum of a maximum bit rate of the first distribution signal and a maximum bit rate of the second distribution signal,
wherein the compression encoder engine is configured to apply lossless compression to the data signal when a bit rate of the data signal is less than or equal to the sum of the maximum bit rate of the first distribution signal and the maximum bit rate of the second distribution signal, and
wherein the compression encoder is configured to apply lossy compression to the data signal when the bit rate of the data signal is greater than the sum of the maximum bit rate of the first distribution signal and the maximum bit rate of the second distribution signal.

11. A data transmission link comprising:
a data stream source configured to output a data signal;
a data processor comprising:
a compression encoder engine configured to receive the data signal and to compress the data signal to output a compressed data signal;
a compression buffer configured to receive the compressed data signal and to buffer the compressed data signal to output a buffered data signal; and
a link distributor configured to retrieve the buffered data signal and to distribute the buffered data signal to at least one of a first distribution signal or a second distribution signal according to a compression ratio; and
a source communication controller configured to receive the first distribution signal and the second distribution signal, the source communication controller comprising a plurality of forward channels and at least one auxiliary channel, which is bi-directional.

12. The data transmission link of claim 11,
wherein the data signal has a first bit rate,
wherein the compressed data signal has a second bit rate,
wherein the compression ratio is a ratio of the first bit rate to the second bit rate, and
wherein the first distribution signal has a maximum bit rate.

13. The data transmission link of claim 12, wherein the link distributor is configured to distribute the buffered data signal entirely to the first distribution signal when the compression ratio is greater than or equal to a reference value.

14. The data transmission link of claim 13, wherein the link distributor is configured to:
calculate a size of a first portion of the buffered data signal and a size of a second portion of the buffered data signal according to the compression ratio when the compression ratio is less than the reference value;
retrieve the first portion and the second portion of the buffered data signal from the compression buffer when the compression ratio is less than the reference value;
distribute the first portion of the buffered data signal to the first distribution signal when the compression ratio is less than the reference value; and
distribute the second portion of the buffered data signal to the second distribution signal when the compression ratio is less than the reference value.

15. The data transmission link of claim 14, wherein the source communication controller comprises:
a forward channel serializer configured to receive the first distribution signal, to serialize the first distribution signal to generate first serialized data, and to transmit the first serialized data to the forward channels; and
an auxiliary channel serializer configured to:
receive the second distribution signal and auxiliary data;
serialize the second distribution signal to generate second serialized data; and
selectively transmit the second serialized data to the at least one auxiliary channel when the serialized data comprises the second portion of the buffered data; and
selectively pass through the auxiliary data via the at least one auxiliary channel when not transmitting the second serialized data.

16. The data transmission link of claim 15,
wherein the forward channel serializer and the auxiliary channel serializer are configured to concurrently transmit the first serialized data and the second serialized data, and
wherein the data transmission link is configured to provide real time communication.

17. The data transmission link of claim 15,
wherein each of the forward channels has a maximum bit rate, and
wherein the first distribution signal's maximum bit rate is equal to a sum of each of the forward channels' maximum bit rate.

18. A method of controlling transmission of data in an apparatus comprising a plurality of forward channels and at least one auxiliary channel, the method comprising
receiving a data signal having a first bit rate and a maximum bit rate;
compressing the data signal to generate a compressed data signal;
calculating a compression ratio of the data signal to the compressed data signal;
buffering the compressed data signal to generate a buffered data signal; and
selectively distributing the buffered data signal to at least one of a first distribution signal or a second distribution signal according to the compression ratio,
wherein the first distribution signal and the second distribution signal each have a maximum bit rate,
wherein the first distribution signal corresponds to the forward channels, and
wherein the second distribution signal corresponds to the at least one auxiliary channel.

19. The method of claim 18, wherein the selectively distributing the buffered data signal to at least one of the first distribution signal or the second distribution signal comprises:
distributing the buffered data signal entirely to the first distribution signal when the compression ratio is greater than or equal to a reference value.

20. The method of claim 19, wherein the reference value is equal to a ratio of the first bit rate to the first distribution signal's maximum bit rate.

21. The method of claim 19, wherein the selectively distributing the buffered data signal to at least one of the first distribution signal or the second distribution signal further comprises:
calculating a size of a first portion of the buffered data signal and a size of a second portion of the buffered data signal according to the compression ratio when the compression ratio is less than the reference value;
retrieving the first portion and the second portion of the buffered data signal when the compression ratio is less than the reference value;
distributing the first portion of the buffered data signal to the first distribution signal when the compression ratio is less than the reference value; and
distributing the second portion of the buffered data signal to the second distribution signal when the compression ratio is less than the reference value.

22. The method of claim 21, further comprising:
serializing the first distribution signal to generate first serialized data;
demultiplexing the first serialized data to generate a plurality of first serialized data streams;
respectively transmitting each of the first serialized data streams to one of the forward channels;
serializing the second distribution signal to generate second serialized data when the compression ratio is less than the reference value;
transmitting the second serialized data to the at least one auxiliary channel when the compression ratio is less than the reference value; and
allowing auxiliary control data to pass via the at least one auxiliary control line when the compression ratio is greater than or equal to the reference value.
